(19) United States
(12) Patent Application Publication
(10) Pub. No.: US 2014/0054005 A1
(43) Pub. Date: Feb. 27, 2014

(54) Viscous Damping Stabilizer

(71) Applicant: AREVA NP Inc., Lynchburg, VA (US)

(72) Inventors: Donald R. Stewart, Bedford, VA (US); Jeffrey C. Brown, Forest, VA (US); Jeffrey M. Fleck, Forest, VA (US)

(73) Assignee: AREVA NP Inc., Lynchburg, VA (US)

(21) Appl. No.: 13/968,524

(22) Filed: Aug. 16, 2013

Related U.S. Application Data
(60) Provisional application No. 61/692,016, filed on Aug. 22, 2012.

(51) Int. Cl. F22B 37/20; F16F 7/00; F16F 7/01

(52) U.S. Cl. CPC F22B 37/206; F16F 7/01; F16F 7/00
USPC 165/69; 188/266; 188/268

(57) ABSTRACT

The inventive viscous damping tube stabilizer includes modules or capsules containing a viscous material. Adjacent capsules are linked end to end by a flexible cable, allowing the device o pass through curves such as the U-bend regions of steam generator tubes. The weight of the entire assembly will keep it essentially connected to the tube inner diameter such that any tube vibration is transmitted to the stabilizer. The viscous material may only partially fill the capsules such that even under small motion the material can slip and slide past each other, and/or bump into walls, each microscopically absorbing some of the tube energy. By creating multiple cells inside the capsule, the capsule then have good operating characteristics no matter to what angle the individual capsule is oriented as it rests on the full U-bend. The viscous material may completely fill the capsules, which also have a perforated member positioned therein. Relative movement of the capsule and disc causes the viscous material to pass through the perforations, providing damping resistance to the movement.

### CROSS-REFERENCE TO RELATED APPLICATIONS

This patent application claims the benefit of U.S. Provisional Patent Application No. 61/692,016 filed on Aug. 22, 2012, which is incorporated herein by reference in its entire

### BACKGROUND OF THE INVENTION

1. Field of the Invention

The present invention relates to a stabilization system, and, more particularly, the present invention relates to a system for stabilizing the in-plane flow-induced vibration of heat transfer device tubes.

2. Description of the Related Art

While the present invention may be used in a variety of industries, the environment of a pressurized water reactor (PWR) nuclear power plant will be discussed herein for illustrative purposes. There are two major systems utilized in a PWR to convert the heat generated in the fuel into electrical power. In the primary system, primary coolant is circulated past the fuel rods where it absorbs the emitted heat. The heated fluid, which is in liquid form due to the elevated pressure of the primary loop, flows to the steam generators where heat is transferred to the secondary system. After leaving the steam generators, the primary coolant is pumped back to the core to complete the primary loop. In the secondary loop, heat is transferred to the secondary coolant, or, feedwater, from the primary side in the steam generators, producing steam. The steam is used to rotate a turbine, generating electricity. The wet steam leaves the turbine, passes through a condenser to remove residual heat, and the liquid feedwater is pumped back to the steam generators.

Inside of the steam generator, the hot reactor coolant flows inside of the many tubes and the feedwater flows around the outside of the tubes. There are two forms of steam generators: once-through steam generators, in which the tubes are straight, and U-bend steam generators, which are more common and in which the tubes contain a U-shaped bend.

Typical heat exchangers, steam generators in the nuclear industry in particular, are susceptible to unacceptable levels of vibration of the internals. This is due to flow-induced forces on tubing during normal operation. Such unacceptable behavior may occur in the straight legs, or in the case of U-tube heat exchangers, in the U-bend region. The U-bend region often represents a larger challenge because the fluid flow is largely cross-flow rather than axial, and the fluid is two-phase. The normal industrial practice is to analyze, design, and construct the heat exchanger with specific supports, called anti-vibration bars (AVBs), that directly and positively act against tube instability in the out-of-plane direction (that is, against the plane defined by the U-bend tube). Commonly, AVBs, however, are not designed with specific features to prevent instability in the in-plane direction (that is, within the plane defined by the U-bend tube).

Recently, tube-to-tube wear has been detected within steam generators. The observed rapid wear is indicative of tube-to-tube contact during power operation, and has been attributed to tube instability in the U-bend area. The tube motion is in the in-plane direction (movement back and forth parallel to the anti-vibration bars). It has been concluded that the in-plane instability is due to a lack of sufficient friction between the anti-vibration bars and the tubes, which renders the AVBs ineffective at preventing in-plane motion of the tube.

When a tube is plugged and removed from service, it may still be at risk for excessive vibration and instability, which could lead to damaging other tubes it may touch, or may itself experience so much wear that loose pieces are generated which can then move over larger distances and cause damage on tubes far removed from the source tube.

Several classic repair approaches exist for stabilization of a tube. One such approach includes installing a relatively stiff cable inside the tube and passing it entirely around the U-bend, which provides mechanical friction if it is vibrating and also prevents, in the event of complete sever of the outer tube, the tube ends, or pieces of tubing, from becoming loose parts which can “migrate.” Another common approach involves installing additional stiffness to the tube, such that, while no significant damping may be added, the vibrational characteristics of the tube are modified sufficiently to preclude risk of flow-induced instability in the given operating conditions. A third approach, used only if there is access from the secondary side, is to attempt to “lock” the tube into place by devices from the secondary side.

High vibration and flow induced instability are inherent risks and design challenges in all heat exchangers whether the tubes have u-bends or are simply straight. The standard stabilizers used in industry for insertion inside the tube all rely on either stiffening the tube to change its natural modal frequencies, and/or creating damping by frictional rubbing between the components of the stabilizer itself and/or frictional rubbing or impacting of the stabilizer onto the inner diameter surface of the tube. These standard stabilizers all depend on the amount of flexural deflection and relative mismatch of their natural frequencies. A further technique that has been used, although not commonly, is to locally expand the tube into various supports so that it is highly restricted in motion by physical interference.

Known stabilizing equipment does not provide significant damping for U-bend in-plane motions (that is to say, it provides much less damping than observed for out-of-plane and for straight leg application). It was also discovered that this in-plane instability would require unusually high levels of damping to allow a plugged tube to have sufficient margin against in-plane instability on those steam generators.

Cable stabilizers can provide damping as high as 10% in the straight legs; however, the same stabilizer delivers less than 2% damping in large radius bends. It is believed that this is due to the cable laying tight to the inner radius of the tube bore due to its weight, and in low amplitude vibration levels there is no significant relative motion of the cable and tube, nor significant flexing of the cable strands, which otherwise would generate desired rubbing friction and thus energy absorption.

Methods for stiffening a tube involve inserting rigid bars or tube sleeves, however neither of these is plausible for insertion into a curved tube, and which is also preceded by a straight leg portion having a length as great as 30 feet.

Thus, what is needed is a suitable repair method to allow power operation at as high a power level as can be safely attained and/or which can be applied to any heat exchangers that might experience in-plane instability.

### SUMMARY OF THE INVENTION

The inventive viscous damping tube stabilizer includes modules or capsules containing a viscous material. Adjacent capsules are linked end to end by a flexible cable or coupling, allowing the device to pass through cures such as the U-bend regions of steam generator tubes. The weight of the entire assembly will keep it essentially connected to the tube inner diameter such that any tube vibration is transmitted to the stabilizer. The viscous material only partially fills the capsules such that even under small motion the material can slip and slide past each other, and/or bump into walls, each microscopically absorbing some of the tube energy. By creating multiple cells inside the capsule, the capsule then will have good operating characteristics no matter to what angle the individual capsule is oriented as it rests on the full U-bend.

Alternatively, the capsules can be substantially filled with viscous material with a perforated disc arranged substantially perpendicular to the capsule longitudinal axis, contacting the inner diameter of the capsule. The disc is affixed to a small diameter cable passing through the capsule. Relative movement between the disc/cable and capsule forces the viscous material to pass through the disc perforations, providing damping resistance to the movement.

### DESCRIPTION OF THE DRAWINGS

The present invention is described with reference to the accompanying drawings, which illustrate exemplary embodiments and in which like reference characters reference like elements. It is intended that the embodiments and figures disclosed herein are to be considered illustrative rather than restrictive.

FIG. 1 shows a capsule component of a viscous damping device of the present invention.

FIG. 2 shows the capsule FIG. 1 in an operational configuration.

FIG. 3 shows a viscous damping device of the present invention.

FIG. 4 shows viscous damping device of FIG. 3 in place within a U-bend tube of a steam generator.

FIG. 5 shows a viscous damping device of the present invention with detailed views of horizontal and vertical capsules.

FIG. 6 shows a viscous damping device of the present invention with a detailed view of an individual capsule.

FIG. 7 shows a viscous damping device of the present invention

### DETAILED DESCRIPTION OF THE INVENTION

The present invention relates a device for stabilizing the in-plane flow-induced vibration of heat transfer device tubes. This device, when inserted inside a heat exchanger tube, provides a high level of damping against vibrations, with the end objective of stabilization against risk of flow-induced instability. Unlike the standard design approach, which adds stiffness and/or frictional damping, the inventive device applies viscous damping using tiny particles as equivalents to a fluid. This solves many challenges in working the extreme temperature and pressure and chemistry-sensitive environments of many heat exchangers.

This invention further provides a high level of damping against in-plane tube motions, which can otherwise cause performance degradation and/or great difficulty for existing designs of tube cable stabilizers.

In a preferred embodiment, the inventive viscous damping tube stabilizer includes modules or capsules containing small-grain material, and the capsules are linked end to end by a flexible cable or coupling or other means of flexible coupling that would be apparent to persons skilled in the relevant art. Such flexible connection allows the device to pass through curves such as the U-bend regions of steam generator tubes. The weight of the entire assembly will keep it essentially connected to the tube inner diameter (ID) such that any tube vibration is transmitted to the device. If the capsules were solid, then the device would only add mass, not significant damping to the tube. The small grain particles, however, only partially fill the capsules such that even under small motion the grains can slip and slide past each other, and/or bump into walls, each microscopically absorbing some of the tube energy. By creating multiple cells inside the capsule, the capsule then will have good operating characteristics no matter to what angle the individual capsule is oriented as it rests on the full U-bend. There is no particular need to optimize the capsule for its final position angle, allowing more economical manufacturing.

Alternatively, the capsules may be filled with a viscous liquid in lieu of particles.

FIG. 1 shows a preferred embodiment of the viscous damping stabilizer 10 of the present invention. The device 110 includes an outer capsule 1 that defines an enclosed body. The capsule 1 is elongate, having an end cap 2. at each of its ends. The end caps 2 allow the capsule 1 to be connected to other, similar capsules 6. The length of the capsule I allows the stabilizer 10, including a plurality of interconnected capsules 1, to be flexible.

The capsule 1 contains interior walls 4 that extend substantially perpendicularly to the longitudinal axis of the capsule 1. The interior walls 4 define a plurality of subcompartments 3 within the capsule.

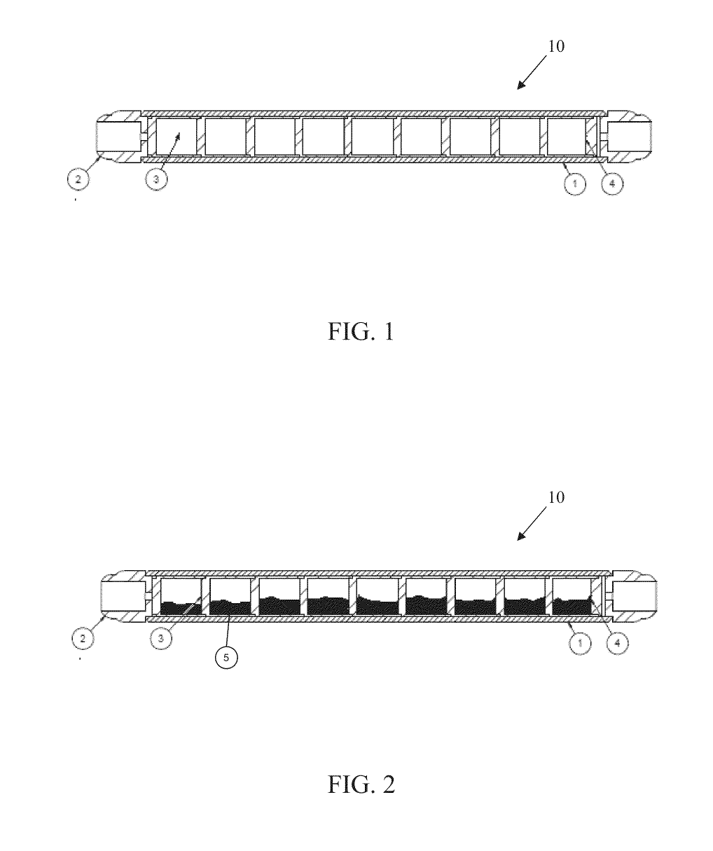

FIG. 2 shows the same stabilizer 10, but the subcompartments 3 contain damping material 5. This damping material 5 may include, for example, a viscous fluid and/or a small grain particle. In this example arrangement illustrated in FIG. 2, the capsule subcompartments 3 are nested cups that are each partially filled with a viscous material.

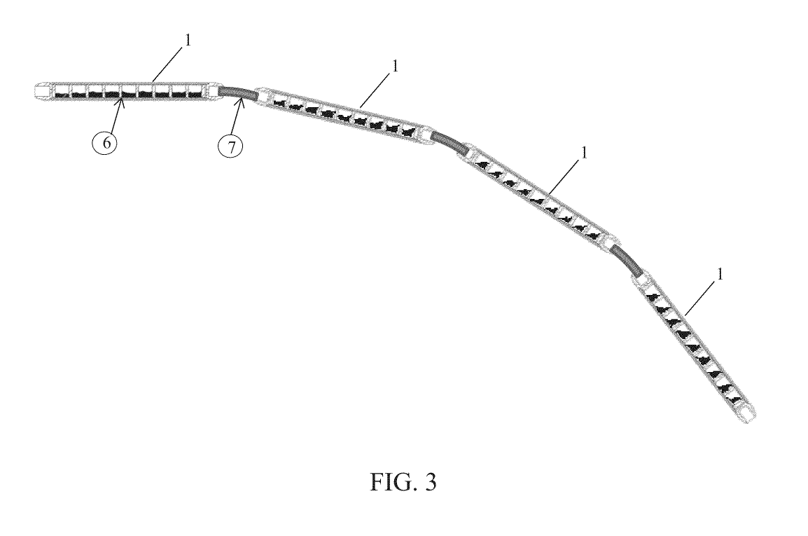

In the assembly of the stabilizer, the capsules 1 are linked for flexibility, and supported as needed by cables. The cables are connected to a tube plug at the primary face of the tube sheet. FIG. 3 shows a viscous damping device 10 of the present invention, that includes a plurality of capsules 1 interconnected by a flexible linking member 7. Four capsules 1 are shown in the illustrated embodiment of FIG. 3 for illustrative purposes; the user can include any number of capsules 1 depending on the circumstances of the particular case. In the partial view of FIG. 3, it is evident the material will flow appropriate to the general angle of the capsule. Due to compartmenting, there is an abundance of top-surface area, leaving much of the grains free to easily move/slide/shear. The more the vibration force (g-force of acceleration/deceleration), the more grains are disturbed and the more energy absorbed.

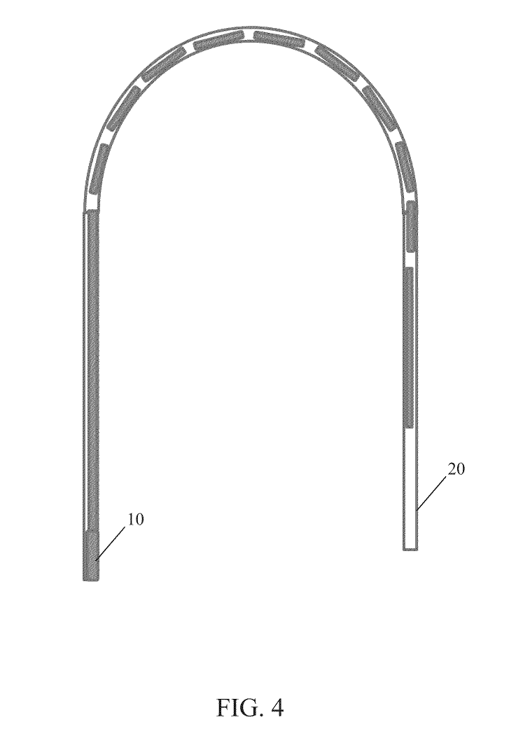

FIG. 4 shows the viscous damping device 10 in place within a U-bend tube 20 of a steam generator. The capsules 1 need only be located where they are most needed. In the particular configuration illustrated in FIG. 4, the capsules 1 are supported by a length of cable or rigid members, and added cable may also be added to the nose if necessary. On the left end of the stabilizer 10, the cable is attached to the end of a tube plug to secure it.

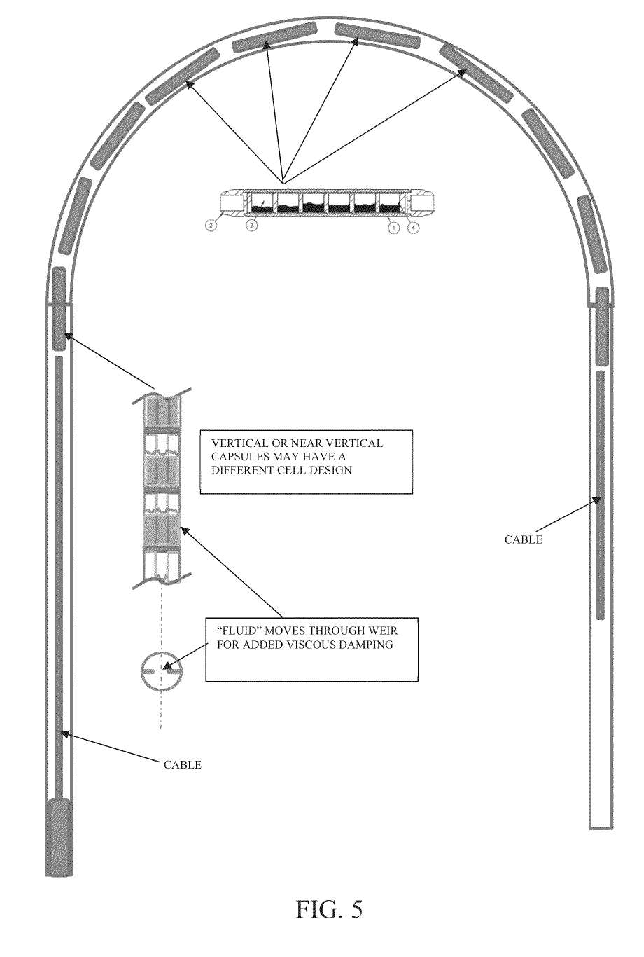

FIG. 5 shows an example stabilizer with detailed views of horizontal and vertical capsules thereof. The length of the capsules allows the stabilizer to “bend” around the U-bend tubes. The stabilizer capsules are linked together via a flexible linking member, such as a cable. Ends of the stabilizer may be coupled to cables to retain the stabilizer in place within the tube.

The damping material only partially fills the capsules. As shown in the illustrated embodiments of FIGS. 2 and 5, the capsules are approximately 40% -60% filled with damping material. The vertically-oriented capsules may include one or more weirs for added damping.

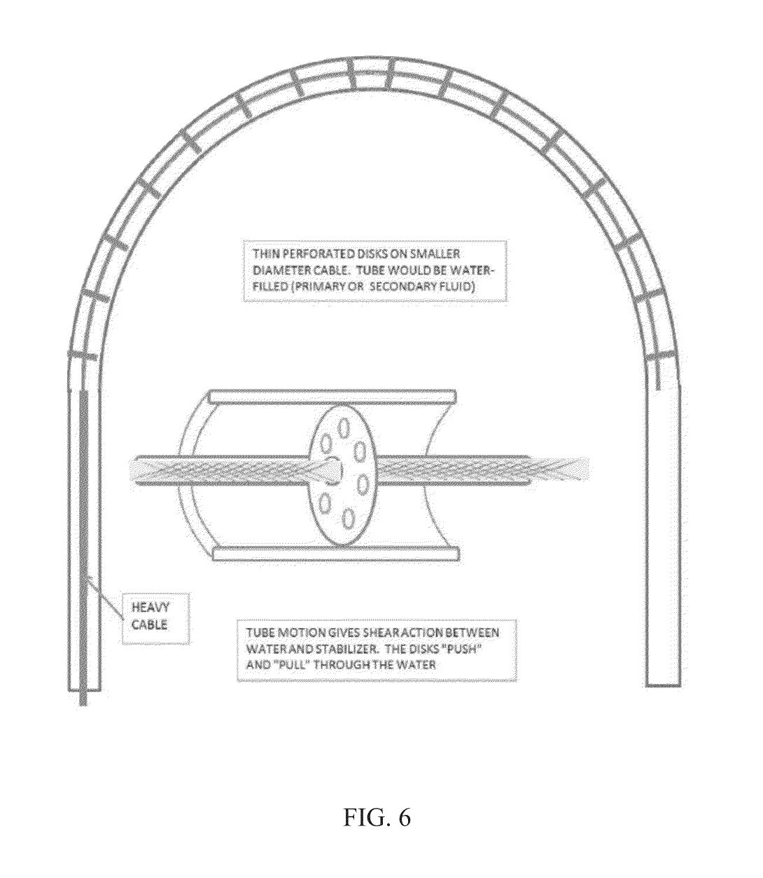

FIG. 6 shows a viscous damping device of the present invention, shown in a different perspective since this approach does not incorporate physical capsules, in contrast to the embodiment illustrated in FIG. 1. In the example embodiment of FIG. 6, a virtual capsule can be considered created; the interior walls 4 create subcompartments 3, and the virtual capsule 1 is created by the inner diameter of tube 20. FIG. 6 shows a detailed view of an individual “capsule.” In this example embodiment, the capsule has an outer wall defined by the inner diameter of the tube 20, defining a hollow interior. A small diameter cable runs through the interior of the capsule. One or more perforated discs (acting as part 4) are positioned within the capsule, substantially perpendicular to the capsule longitudinal axis and preferably contacting or in close contact with the inner surface of the tube which is the virtual capsule 1. The cable passes through a central portion of the discs and is affixed thereto. A single cable can be used with the several disks 4, creating capsules and thus comprising a stabilizer. The entire tube and thus capsule is filled with a viscous material, preferably fluid in this embodiment. Such a condition can be achieved, for example, by allowing the otherwise dry tube to be full of primary fluid using tiny orifice tube plugs which allow primary water to fill the tube (which must still not have any leaking defects), or by purposely perforating the tube to allow secondary fluid to fill the tube, or by using an acceptable other fluid to fill the tube.

Relative movement between the fluid and the disc causes the viscous material to pass through the disc perforations, viscously damping this relative movement. The disks 4 are dimensioned so as to be retained in place within the tube via, friction, and the cable, which is affixed to the tube sheet. Thus, if the tube moves in an in-plane direction, such as by flow induced vibration, whereas the fluid would normally allow the tube to easily slip at a film shear plane at the tube inner diameter, relative sliding of the tube will now force some fluid to pass through the disc perforations and provided a damping resistance to the tube movement. The fluid (water for example) in the virtual capsules is pushed back and forth by the perforated disks.

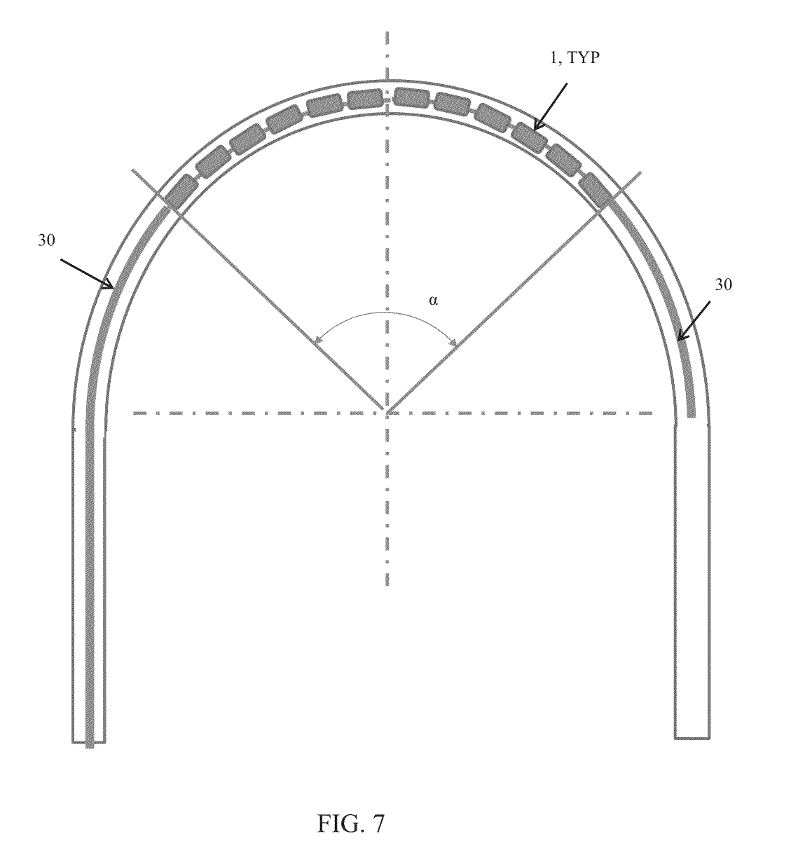

FIG. 7 shows a viscous damping device of the present invention. The capsules 1 are positioned within the U-bend portion of the tube with ends of the stabilizer coupled to cables 30. The cables are coupled to the tube sheet to retain the stabilizer in place within the tube. The number of capsules is chosen such that they fill the portion of the tube defined by an angle a centered at the geometric center of the U-bend and symmetric about a vertical axis parallel to the straight portions of the tube. Preferably, the capsules fill an angle a of 35°-55°.

In another embodiment of the invention, the damping can be improved by placement of large dense objects within the capsule and/or its subcompartments, such that again the capsule is still just partially filled. Under adequate accelerations and decelerations of the tube motion, the large object will tend to stay stationary and resist the ebb and flow of the viscous material, creating more energy dissipation by friction. The mass is simply viscously coupled to the tube. If and when the large object (such as ball bearings or log-shaped pieces) acquires velocity, it will then slide with the viscous material but continue brief sliding in the same vector direction even after the tube and viscous material have reversed direction due to the tube's natural frequency. This relative sliding continues then to dissipate energy and will do so at each change in direction of the tube vibration. In the embodiment, the mass needs to be substantially greater than that of the grains.

The inventive device provides a significant benefit over existing technologies by providing high level of damping of heat exchanger tubes that are subject to in-plane vibration. The device can be easily fabricated, and has very high reliability since the only moving parts are is fine particles or viscous fluids which tumble, slosh, and slip when moved, beginning at low g-forces. (It is estimated that the stainless shot of 0.005 in. to 0.008 in. in diameter is activated at or below 0.3 g). The invention is believed to be far more sensitive to low level activation forces than are other damping devices used for tube stabilization.

The device can be readily installed inside a heat exchanger tube using tooling normally used for installation of cable-type stabilizers, and can be sized to pass through most or all tube radii which may need stabilization against flow-induced instability. The length and diameter of the capsules are fully adjustable and define the radius through which they can pass. Ideally, for a given application only the length is adjusted for a range of tube radii, installing fewer or more subcompartments in each, as appropriate.

The inventive device offers substantial damping against both in-plane and out-of plane motions, and will far exceed the damping generated by industrially used stabilizer cable. It creates the damping by freely allowing relative particle motion of small-grained material, which acts very similar to viscous fluids.

The viscous material can ideally be tiny shot, such as is used for commercial shot-peening. Small-grain shot is preferred over larger shot since it is believed to have a lower slip-coefficient, and thus will slip at lower g-forces. Shot in the size of 0.005 in. to 0.008 in. diameter is found to perform very well in ¾ in. tubing and is expected to also work well in most applications for nuclear steam generators. Other size shot may also be used and is not excluded. Preferably, the fine-grain material is not true round spheres, which tend to roll with low friction. Instead, it is preferred to use random rounded cut wire, which is not truly round and which has a greater sliding component to its motions. Stainless steel or other metal fully compatible with the operating environment is preferred, as the shot will not introduce corrosion-related risk to the operation of the heat exchanger, even if some material were to be lost. Fine-grained materials with sharper edges, such as most sands or ceramic grains, are also suitable for use. These materials, however, are less desirable for low amplitude low g-force oscillations because they will have a higher slip coefficient than highly rounded particles, and thus require more energy to initiate relative slip. Additionally, actual viscous liquids can be used, should the material be suitably compatible with the environment.

Except in the configuration shown in FIG. 6, the capsule and its compartments are not completely full of the viscous material, allowing the material room to slosh and slip, thereby absorbing energy. A completely full volume of like-material would not have this characteristic and would act like a solid material with no significant damping.

The capsules are able to sustain large external pressures, and sealing including seat-welding of the ends of the capsules lend to easy fabrication and inspection control. While it is preferable to completely seal the capsules from external pressure, some in-leakage of the secondary fluid of a steam generator should not completely destroy that capsule's damping characteristic. Further, the existence of multiple capsules provides significant assurance of good overall performance.

The form of the subcompartments can vary. For example, the subcompartments can be formed by using a plurality of singular cups which are each prefilled to the desired volume of viscous material and simply nested together as they are inserted inside the capsule. This may be desired if the viscous material is particulate. As another example, a series disks each joined and spaced by a slender member, the disks forming a close seal with the capsule ID. As another example, each compartment can be self-sealed and coupled, such as by screw threads, into its adjacent neighbor to form a longer assembly or capsule. The total length of this capsule can be readily adjusted by the number of consecutive compartments. in any event, the compartmentalization components can provide an additional function of providing support of the inner diameter of the capsule, helping to protect against collapse under external pressure.

The compartment design can be customized for the viscous fluid used and the compartment orientation when placed within a steam generator tube. For example, for vertical or near vertical capsules using viscous fluid, a preferred embodiment would be the inclusion of a “weir gate” in the subcompartments, such that fluid (or small particles) must pass through the weir as a choke point in traversing towards the opposite chamber. As another example, a mesh can be inserted inside the compartment, which creates more surface to force interference and turbulence for the material as it shifts. The compartments can also be easily optimized in length, the length and number of compartments being considered as some of the parameters affecting damping performance. Compartments of length approximately equal to its inside diameter are generally deemed preferable.

The individual capsules can be linked together, which would allow the stabilizer to pass over a vertical U-bend and stay in the desired operational position. Those skilled in the art of fabrication would recognize that flexible members can be, for example, short sections of flex cable brazed to the ends of the capsule, or welded, or crimped. Alternatively, the joints can be mechanically swiveling, or articulating.

The stabilizer can be attached to a long section of cable to push or pull it into the U-bend region. However, the device will perform equally well along vertical straight legs, so the amount of cable before and after the capsule region may be an economic and performance assessment.

While the preferred embodiments of the present invention have been described above, it should be understood that they have been presented by way of example only, and not of limitation. It will be apparent to persons skilled in the relevant art that various changes in form and detail can be made therein without departing from the spirit and scope of the invention. Thus the present invention should not be limited by the above-described exemplary embodiments, but should be defined only in accordance with the following claims and their equivalents. Furthermore, while certain advantages of the invention have been described herein, it is to be understood that not necessarily all such advantages may be achieved in accordance with any particular embodiment of the invention. Thus, for example, those skilled in the art will recognize that the invention may be embodied or carried out in a manner that achieves or optimizes one advantage or group of advantages as taught herein without necessarily achieving other advantages as may be taught or suggested herein.

What is claimed is:

1. A stabilizer for use with a hollow tube, comprising a plurality of capsules, adjacent ones of said capsules being interconnected by a flexible linking member, said capsules containing damping material that is free to move about an interior volume of said capsules.

2. The stabilizer of claim 1, wherein at least one of said capsules defines a plurality of subcompartment therein, each of said subcompartments containing damping material.

3. The stabilizer of claim 2, wherein each of said subcompartment defines a volume that is partially filled with damping material.

4. The stabilizer of claim 3, wherein each of said subcompartment volumes is 40%-60% filled with damping material.

5. The stabilizer of claim 1, wherein at least one of said capsules further includes a perforated member therein, said capsule being substantially filled with damping material.

6. The stabilizer of claim 1, wherein said damping material is in the form of fine particles.

7. The stabilizer of claim 6, wherein said particles have a non-uniform shape.

8. The stabilizer of claim 1, further comprising an insert positioned within at least one of said plurality of capsules, said insert having a mass that is greater than a mass of said damping material within said at least one capsule.

9. The stabilizer of claim 1, further comprising a plurality of inserts, each of said plurality of capsules having an insert positioned therein, each of said inserts having a mass that is greater than a mass of said damping material within said respective capsules.

10. A method of stabilizing a bent hollow tube, comprising:
providing a stabilizer including a plurality of capsules, adjacent ones of said capsules being interconnected by a flexible linking member, said capsules defining an interior volume in which a damping material is positioned;
positioning said stabilizer within the tube; and
securing ends of said stabilizer to one or more ends of the tube.

11. The method of claim 10, wherein said providing includes providing a stabilizer having a capsule that defines a plurality of subcompartments, each of said subcompartments defining a volume that is partially filled with damping material.

12. The method of claim 11, wherein each of said subcompartment volumes is 40%-60% filled with damping material.

13. The method of claim 10, wherein said providing includes providing a stabilizer having a capsule that further includes a perforated member therein, said capsule being substantially filled with damping material.

14. The method of claim 10, wherein said providing includes providing damping material in the form of fine particles.

15. The method of claim 14, wherein said providing further includes providing damping material having a non-uniform shape.
